(19) United States
(12) Patent Application Publication
(10) Pub. No.: US 2008/0263828 A1
(43) Pub. Date: Oct. 30, 2008

(54) HINGE AND METHOD OF MAKING SAME

(76) Inventors: Andre Bultschnieder, Rheda-Wiedenbruck (DE); Uwe Sabrowski, Rheda-Wiedenbruck (DE)

Correspondence Address: K.F. ROSS P.C., 5683 RIVERDALE AVENUE, SUITE 203 BOX 900, BRONX, NY, 10471-0900, US

(21) Appl. No.: 12/107,917

(22) Filed: Apr. 23, 2008

(30) Foreign Application Priority Data
Apr. 27, 2007 (DE) 102007019939.4

(51) Int. Cl. E05D 9/00

(52) U.S. Cl. 16/385

(57) ABSTRACT

A method of making a hinge has the steps of forming a region of a piece of sheet metal with a groove and then bending the piece of sheet metal to form the region into an eye with the groove opening inwardly into the eye so that the piece of sheet metal with the eye forms a first leaf. A pivot pin with a radially outwardly projecting thickened region is fitted and pressed into the eye such that the radially thickened region radially elastically widens the eye. Once the thickened region reaches the groove, the eye springs back so that the pivot pin is then captured held in the eye.

### FIELD OF THE INVENTION

The present invention relates to a hinge. More particularly this invention concerns a pin-type hinge and method of making it.

### BACKGROUND OF THE INVENTION

A standard hinge has a first leaf and a second leaf that are connected at a pivot axis by a pin. At least the first leaf is made of sheet metal and has at least one not completely closed pivot eye. The eye is open at its ends so that the pivot pin must be secured against falling out.

A hinge of this type is known from German patent publication 201 15 722 in which the leaves each have three pivot eyes. The eyes of the two leaves of the two leaves are interleaved and coaxially aligned to receive a pivot pin and form a continuous pivot. In order that the pin does not fall out of the pivot that is open at its ends, one pivot eye is radially inwardly deformed to have a tapered area. The recess on the outside of the pivot eye produced by the deformation can be easily seen and has a significant adverse effect on the looks of the hinge. Furthermore, the considerable force needed for the plastic deformation that creates this shape can also have the result that the entire hinge warps.

German patent publication DE 819 210 describes a plate with two leaves connected to one another by a pintle. In order to fasten the pintle it is also rolled in place when the pivot eye is made, the eye either being formed by bending or having an indentation at the level of the eye. The looks of the plate are also adversely affected in this example by the deformation and also by an indentation.

Furthermore, it is known from practice that the pivot pin can be secured by a spring ring, a safety screw or a safety bolt. However, stocking additional structural parts and assembling them, as is suggested for example in DE 87 01 146, is disadvantageous on account of the increased costs. In this example the pin is designed as a complicated multipart bolt.

### OBJECTS OF THE INVENTION

It is therefore an object of the present invention to provide an improved hinge and method of making same.

Another object is the provision of such an improved hinge and method of making same that overcomes the above-given disadvantages, in particular where the pivot pin is secured against falling out without further structural parts and without an optically adverse effect on the looks of the hinge.

### SUMMARY OF THE INVENTION

A method of making a hinge has according to the invention the steps of forming a region of a piece of sheet metal with a groove and then bending the piece of sheet metal to form the region into an eye with the groove opening inwardly into the eye so that the piece of sheet metal with the eye forms a first leaf. A pivot pin with a radially outwardly projecting thickened region is fitted and pressed into the eye such that the radially thickened region radially elastically widens the eye. Once the thickened region reaches the groove, the eye springs back so that the pivot pin is then captured held in the eye.

The shape of the groove and the thickened region must be made generally complementary and the pivot pin preferably has a certain axial play when fitted therein. Tolerances can be compensated for in an especially simple manner by the play provided between the thickened region and the groove. The pressing-in of the pivot pin can take place without limitation by a machine with a press or by a manually driving it in.

According to a preferred embodiment of the invention the second leaf, which is made of sheet metal, has a pivot eye that is aligned between the pivot eye provided with the groove and a second outer pivot eye of the first leaf, the first leaf and the second leaf thus being inseparably connected by the pressing-in of the pivot pin. The slight but nevertheless present elasticity of the inherently stable structural parts is utilized here during the assembly by the action of force on the pivot pin. However it is also possible without limitation in the scope of the invention that the two leaves, as is also known from DE 202 15 722, each have several pivot eyes that form a continuous pivot in a coaxial arrangement. In order to ensure easy action of the hinge and to reduce wear, glide disks or slide sleeves can be arranged between the pivot eyes.

In the hinge according to the invention both leaves are preferably made of sheet metal without the further design of the hinge being limited. Thus, for example both leaves have bores for fastening to a door frame or a door wing. According to an alternative embodiment of the invention, one of the leaves is adjustability held in a leaf holder that can be set in a door wing or a door frame.

### BRIEF DESCRIPTION OF THE DRAWING

The above and other objects, features, and advantages will become more readily apparent from the following description, reference being made to the accompanying drawing in which:

FIG. 1 is a perspective view of a hinge according to the invention; and

FIG. 2 is a large-scale sectional view of a detail of the hinge.

### SPECIFIC DESCRIPTION

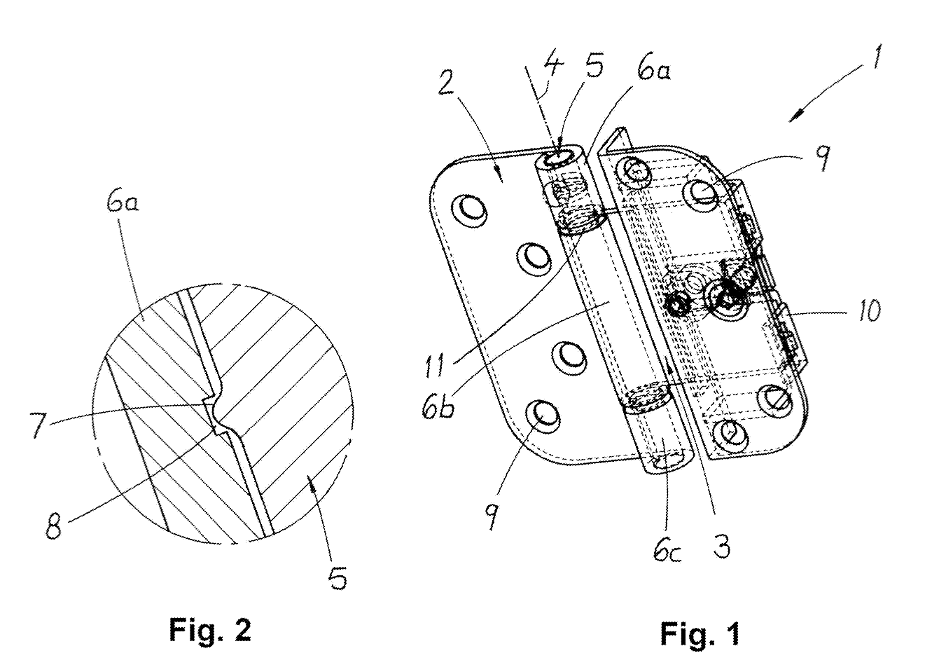

As seen in FIG. 1 a hinge 1 has a first leaf 2 and a second leaf 3 that are both made of sheet metal and are connected at a pivot axis 4 by a pivot pin 5. An inner pivot eye 6b of the second leaf 3 fits between two outer pivot eyes 6a and 6c of the first leaf 2. The pivot eyes 6a, 6b, and 6c are formed from the sheet metal of the first and second leaves 2 and 3 by bending, with the pivot eyes 6a, 6b, 6c not being completely closed.

FIG. 2 shows that the pivot pin 5 has a radially outwardly projecting thickened region 7 produced by longitudinally compressing the pivot pin 5 so that a circumferential ridge is formed as the radially outwardly projecting thickened region 7. The radially outwardly projecting thickened region 7 engages into a respective inwardly open groove 8 of the respective pivot eye 6a of the first leaf 2 in such a manner that it is captured and cannot be lost. The first leaf 2 comprises the second outer pivot eye 6c in addition to the first outer pivot eye 6a with the inwardly open groove 8, and the inner pivot eye 6b of second leaf 3 is aligned on the axis 4 between the pivot outer eyes 6a and 6c of the first leaf 2. The groove 8 is produced during manufacture of the hinge 1 before the bending of the outer pivot eye 6a. Since the circumferential ridge 7 is somewhat smaller than the respective groove 8, the pivot pin 5 pressed into the pivot axis 4 has a slight axial play.

In the described illustrated embodiment the first leaf 2 is provided with bores 9 so it can be fastened directly to a door wing or to a door frame and the second leaf 3 is fastened via a leaf holder 10 in which the position of the second leaf 3 can be varied. Glide washers 11 are arranged between pivot eyes 6a, 6b, 6c for reducing wear and friction.

We claim:

1. A method of making a hinge comprising the steps of:
forming a region of a piece of sheet metal with a groove;
bending the piece of sheet metal to form the region into an eye with the groove opening inwardly into the eye, the piece of sheet metal with the eye forming a first leaf;
providing a pivot pin with a radially outwardly projecting thickened region;
fitting the pin to the eye and pressing the thickened region into the pivot eye such that the radially thickened region radially elastically widens the eye; and
radially springing back the eye when the thickened region of the pivot pin reaches the inwardly open groove so that the pivot pin is then held in the eye.

2. The hinge-making method defined in claim 1, further comprising the steps of:
forming a second groove in the piece of sheet metal; and
bending the piece of sheet metal to form a second eye with the second groove opening inward into the second eye and the second eye spaced from and aligned with the first-mentioned eye.

3. The hinge-making method defined in claim 2, further comprising
providing a second leaf with an eye fittable between the eyes of the first leaf; and
fitting the eye of the second leaf between the eyes of the first leaf such that the pin can pass through all the eyes.

4. The hinge-making method defined in claim 3 wherein the second leaf is formed from sheet metal.

5. The hinge-making method defined in claim 3, further comprising the step of:
fitting slide bushings between the pivot eyes before fitting the pivot pin to the eyes.

6. The hinge-making method defined in claim 1 wherein the pivot pin is elongated and the outwardly projecting thickened region is formed by longitudinally compressing the pivot pin.

7. A hinge comprising:
a first leaf formed with a pair of eyes spaced apart along and centered on an axis, one of the eyes being formed with a radially inwardly open groove;
a second leaf formed with an eye fitted between the and aligned axially with the eyes of the first leaf; and
a pin projecting through the eyes of the first and second leaves and formed integrally with a radially outwardly projecting ridge engaged in the groove of the one eye of the first leaf.
